(19) United States
(12) Patent Application Publication
(10) Pub. No.: US 2011/0110631 A1
(43) Pub. Date: May 12, 2011

(54) Modular, Reconfigurable Video Data Transport System

(76) Inventors: Eugene E. Baker, Somis, CA (US); David C. Pelletier, Southbridge, MA (US); Joseph Curini, Worcester, MA (US)

(21) Appl. No.: 12/878,417

(22) Filed: Sep. 9, 2010

Related U.S. Application Data
(63) Continuation-in-part of application No. 12/206,125, filed on Sep. 8, 2008, now Pat. No. 7,866,896.
(60) Provisional application No. 61/240,733, filed on Sep. 9, 2009.

(51) Int. Cl. G02B 6/36

(52) U.S. Cl. 385/88

(57) ABSTRACT

A configurable, modular video data transport system with a connector module that has an input connector, and output connector, a voltage regulator adapted to be connected to an external power source and provide a regulated power supply output, and a controller operatively coupled to the voltage regulator output, the input connector and the output connector. There are a series of receiver modules each having an input connector and an output connector, the output connector of each receiver module constructed and arranged to mate with the input connector of the connector module so that each receiver module can be directly mechanically and electrically coupled to the connector module and pass data signals to the connector module. There are also a series of transmitter modules each having an input connector and an output connector, the input connector of each transmitter module constructed and arranged to mate with the output connector of the connector module so that each transmitter module can be directly mechanically and electrically coupled to the connector module to receive the data signals from the connector module that were input to the connector module by the receiver module.

### CROSS-REFERENCE TO RELATED APPLICATIONS

This application claims priority of U.S. provisional patent application Ser. No. 61/240,733 filed on Sep. 9, 2009. This application is a continuation in part of and also claims priority of U.S. patent application Ser. No. 12/206,125 filed on Sep. 8, 2008. The disclosures of both priority applications are incorporated herein by reference.

### FIELD

The invention relates to a video data transport system.

### BACKGROUND

Video data can be transported as electrical or optical signals. Video data handling systems would benefit from modular, interchangeable, interconnectable electrical to optical and optical to electrical converters, and electrical to electrical and optical to optical interface modules.

### SUMMARY

This invention features a system with one or more modular electrical to optical video data connectors, and/or one or more optical to electrical video data connectors. The connectors can be electrically and mechanically coupled to a backplane board that is itself adapted to be coupled to a chassis carrying video/audio switching and/or processing boards, such as the openGear DFR-8310 2RU frame available from openGear, Inc. of Sandy, Utah. The openGear product typically can accommodate up to 10 printed circuit boards (PCBs). Each such internal PCB is designed to be coupled to up to 10 electrical coax cables through ten BNC coax connectors held on a rear module (i.e., a backplane board) that is coupled to the PCB at the back of the chassis through standard gold-fingered card edge connectors on the PCB that fit into a pin-type card-edge connector on the backplane. The PCBs process electrical audio/visual signals.

A preferred embodiment of the inventive connection system comprises one or more cube-shaped housings. The housings may carry a fiber optic connector on one side (e.g., an ST-type connector or one of various other standard fiber optic connectors), or an electronic video data connector. The housings carry a pin connector on another side of the housing. The pin connector is adapted to be electrically coupled to a PCB or the like, e.g., a backplane board, such that the housings are electrically coupled to the backplane through a four-pin connector.

The invention includes an optical transmitter module that takes electrical signals from the PCB in the chassis or data line such as a coaxial cable, and transmits optical signals through a standard optical connector, thus accomplishing electrical to optical conversion. Electronics within the housing take in electrical signals passed from a PCB or cable to which the backplane is connected, through the backplane board, into the cube-shaped housing, and create an optical signal. This optical signal is coupled into a fiber that is itself coupled to the optical connector attached to the housing.

The invention also includes a receiver module that receives an optical signal through a standard optical connector and creates an electrical signal, thus accomplishing optical to electrical conversion. Electronics within the housing take in an optical signal and create an electrical signal that is then coupled into a PCB or an output coax cable through the backplane board.

The invention also contemplates placing standard coax-type processing electronics in the same cube-shaped housings that are identical to the optical housings, so that standard coax signals can also be coupled through the backplane if desired, to accomplish electrical to electrical interfacing. The invention further contemplates twisted pair conductors as an alternate to coax media to interface with.

Each of these modules may comprise a generally cube-shaped housing that is sized with such that it occupies about one-eighth of the backplane board, so that up to eight such modules can be coupled to the backplane, thus electrically coupling the modules to the PCB to which the backplane is connected. This may be accomplished with a face area of less than about one square inch, and preferably less than about 0.5 square inches. When the backplane is coupled to an electrical audio/visual processing PCB, the backplane and modules with their internal circuitry act as a means to couple optical signals and/or electrical signals, as desired, into and/or out of a chassis of the type that includes one or more PCBs that process electrical audio/visual signals. As the various types of housings are all the same size, shape and footprint, and are each coupled to the backplane through identical electrical connectors, they can be mixed and matched as desired to achieve up to eight BNC-type electrical and/or optical connections into and out of a processing PCB. The BNC and ST are non-limiting examples of available connectors commonly used for coaxial and fiber optic media respectively. Other electrical or optical connectors are available that can attach coax, optical cable or twisted pair media or the like to these modules, such as an RJ-45 interface or an LC connector.

In another non-limiting embodiment, the modules can be mounted to PCBs that function not as a backplane, but as an interface for signals to and from electronic equipment. In yet another non-limiting embodiment, the invention features an interface device to which two or possibly more of the modules can be electrically coupled through their pin connectors. The interface device supplies power to the modules that are coupled to it. The interface device provides a cross connection between the output signals of one module and the input signals of the other module attached to the same interface.

The invention also features a configurable, modular video data transport system, comprising a connector module comprising an input connector, and output connector, a voltage regulator adapted to be connected to an external power source and provide a regulated power supply output, and a controller operatively coupled to the voltage regulator output, the input connector and the output connector, a series of receiver modules each comprising an input connector and an output connector, the output connector of each receiver module constructed and arranged to mate with the input connector of the connector module so that each receiver module can be directly mechanically and electrically coupled to the connector module and pass data signals to the connector module, wherein at least one receiver module has a coaxial input connector adapted to be coupled to an input coaxial electrical cable carrying video data and at least one receiver module has an optical fiber input connector adapted to be coupled to an input optical cable carrying video data, and wherein one of the receiver modules is mechanically and electrically coupled to the connector module via the receiver module output connector and is coupled to the input cables, to thereby receive input data signals and pass them to the connector module, and a series of transmitter modules each comprising an input connector and an output connector, the input connector of each receiver module constructed and arranged to mate with the input connector of the connector module so that each transmitter module can be directly mechanically and electrically coupled to the connector module to receive the data signals from the connector module that were input to the connector module by the receiver module, wherein at least one transmitter module has a coaxial output connector adapted to be coupled to a coaxial electrical cable that is adapted to carry electrical video data, and at least one transmitter module has an optical fiber output connector adapted to be coupled to an optical cable that is adapted to carry optical video data, and wherein one of the transmitter modules is mechanically and electrically coupled to the connector module via the transmitter module input connector. The output of the voltage regulator of the connector module is operatively coupled to both the receiver module and transmitter module that are coupled to the connector module so as to provide power to the receiver module and transmitter module. The connector module passes to the transmitter module signals received by it from the receiver module to be transmitted by the transmitter module, and wherein the connector module translates signals received by it from the receiver module as necessary such that the signals are of the correct format for transmission by the transmitter module.

In another non-limiting embodiment, the faces of the modules that are coupled to inputs and outputs are at 90 degree angles rather than parallel. Such right angle versions can be used for both BCN and ST media converter modules.

In yet another non-limiting embodiment, the modules can have more than one signal path to or from them (i.e., more than one input and/or more than one output). These multiple inputs and/or outputs can be on one or more faces of the housing.

This invention features a connector module for interfacing electrical or optical connectors to electrical systems, comprising a housing defining at least first and second faces, at least the second face being less than about one square inch in area, a first electrical or optical connector at the first face, and a second electrical connector at the second face, in which the second electrical connector is a pin connector. The first connector may be an optical connector. In this case, the connector module may further comprise circuitry for translating an incoming optical signal to an outgoing electrical signal, or circuitry for translating an incoming electrical signal to an outgoing optical signal. The first connector may be an electrical connector. In this case, the connector module may further comprise circuitry for translating an incoming electrical signal to an outgoing electrical signal. In one embodiment, the first and second faces are each less than about 0.5 square inches in area, and the housing has a generally rectangular parallelepiped shape, such that the housing is almost cube-shaped.

The connector module may further comprise an electrical backplane to which the second electrical connector is coupled. The backplane may have two faces, in which case the second electrical connector can be coupled to one face of the backplane, with the other face of the backplane coupled to an electrical audio/visual signal processing board. In another embodiment, the second electrical connector may be coupled directly to an electrical audio/visual signal processing board, without the use of an intervening backplane.

The first and second faces of the module may be on opposite ends of the housing and essentially parallel to one another. In another embodiment, the first and second faces are adjacent to one another and are at essentially at 90 degrees to one another. The housing may define a third face that is less than about one square inch in area, and the module may in this case further comprise a third electrical or optical connector at the third face. The invention also features a powered connector module interface device for providing power to and electrically and physically interfacing at least two of the connector modules described herein.

### BRIEF DESCRIPTION OF THE DRAWINGS

Other objects, features and advantages will occur to those skilled in the art from the following description of embodiments of the invention, and the accompanying drawings, in which:

FIG. 1A is a top view and FIG. 1B a side view of a backplane carrying eight modules of the invention;

FIG. 1C is an exploded view of the backplane of FIGS. 1A and 1B being inserted into the edge connectors of an audio/visual signal processing board;

FIG. 2 is a schematic diagram of the electrical connections between the signal processing board and the modules of FIG. 1C;

FIG. 3 is a more detailed perspective view of one arrangement of eight inventive modules on a backplane;

FIG. 4 is a schematic cross-sectional diagram of an inventive module;

FIG. 5 is a schematic block diagram of an optical transmitter module of the invention;

FIG. 6 is a schematic block diagram of an optical receiver module of the invention;

FIG. 7 is a schematic block diagram of an electrical receiver or transmitter module of the invention;

FIG. 8 is a schematic cross-sectional diagram of an inventive interface device for modules of the invention;

FIG. 9A is a side view of the interface device of FIG. 8 with a receive and a transmit module coupled to it;

FIG. 9B is a schematic cross-sectional view of the assembly of FIG. 9A; and

FIG. 10 is a schematic block diagram of the interface device of FIGS. 8 and 9.

### DETAILED DESCRIPTION OF EMBODIMENTS

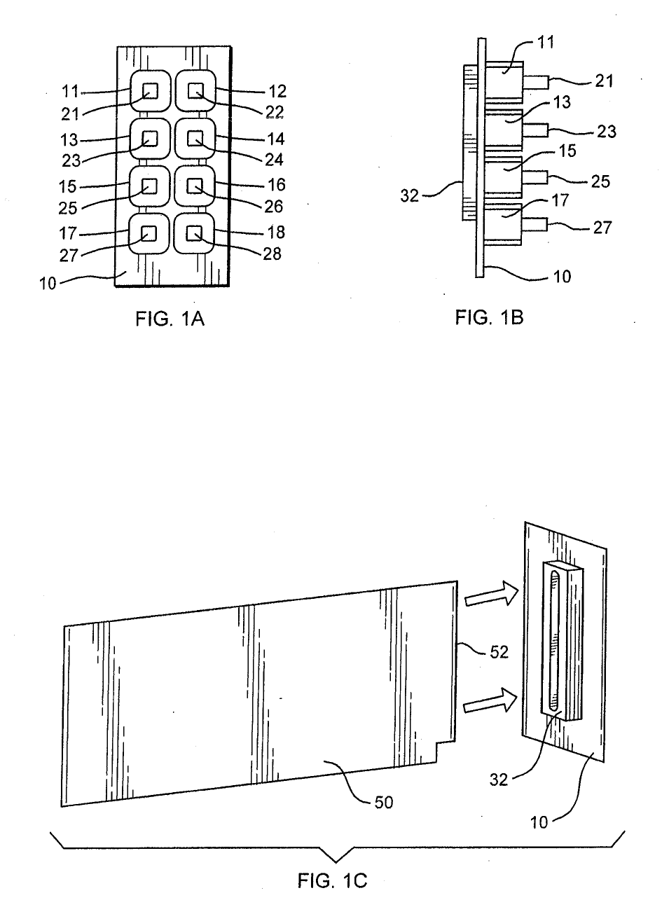

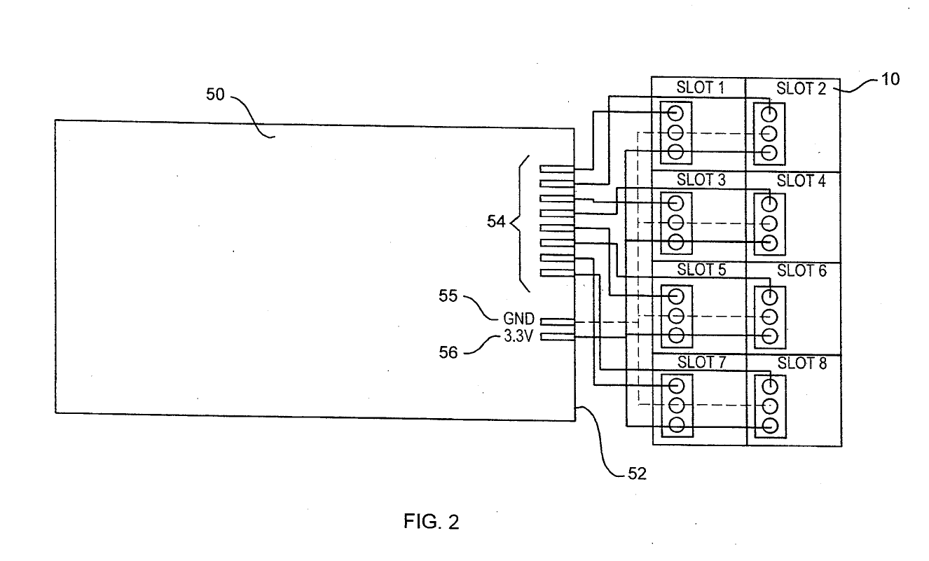

Backplane 10, FIGS. 1A-1C and FIG. 2, includes on its back face connector 32 that is adapted to electrically couple to edge connector 52 of electrical audio/visual processing board 50. The front face of backplane 10 is adapted to electrically couple to up to eight inventive modules 11-18. Each module 11-18 either transmits or receives electrical or optical signals that are being received by or sent by circuitry on PCB 50. Modules 11-18 each include one electrical or optical connector 21-28, respectively, on one face (in this example, the face directly opposite board 10). Each module includes an electrical connector on another face, as explained below. The modules can include more than one connector on any one face and/or connectors on more than two faces.

Board 10 is designed to include eight pin-type electrical connectors (termed slots 1-8 in FIG. 2). Each of these connectors is adapted to physically and electrically mate with the electrical connector on a face of a module 11-18. In an embodiment, these connectors are four-pin connectors. One pin of each connector is electrically coupled to ground 55, and another is electrically coupled to 3.3V source 56. The other two pins (or in some cases only one) are the data input/output pins that are coupled to input/output connectors 54 on audio/visual processing PCBs.

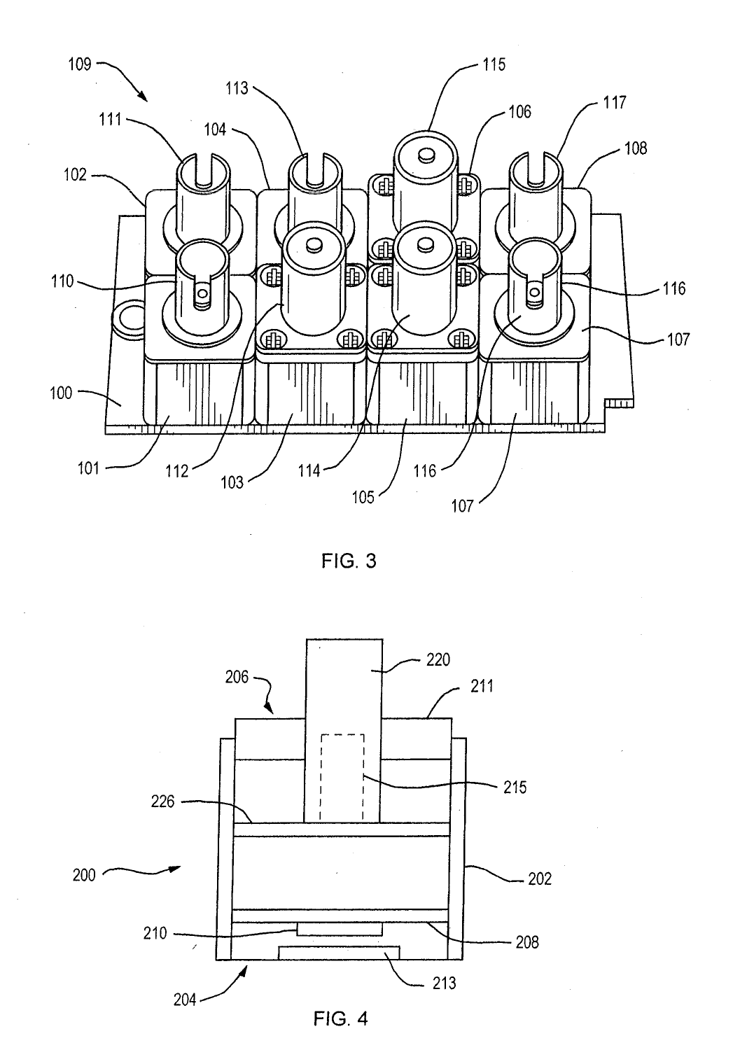

As shown in FIG. 3, each of modules 101-108 mounted to backplane 100 presents an outward facing electrical or optical connector (labeled 110-117, respectively) of a type known in the art. This allows standard electrical and optical audio/visual input and output lines to be coupled to PCB 50 through assembly 109.

Inventive module 200 is shown in FIG. 4 and includes generally cube-shaped housing 202 that defines first face 204 and opposite second face that can each be about 0.668 by 0.650 inches (thus presenting a face defining an area of about 0.43 square inches); this allows eight of modules 200 to fit onto the face of a backplane (such as backplane 100, FIG. 3) of the type that typically holds 10 BNC connectors such as is standard on the openGear frame described above. The invention thus allows for electrical and/or optical inputs and/or outputs to and/or from the processing PCB using the standard PCB edge connection design and the standard backplane footprint.

Housing 202 may be about 0.6 inches high. Module 200 may be about 1.23 to 1.345 inches high including the projecting connector sleeve 220 (this would be an existing electrical or optical conductor, such as the type disclosed herein; a generic representation of such is shown in the drawing) that is mechanically coupled to clamp bracket 211. When used as a receiver, internal PCB 226 electrically or optically terminates the electrical or optical connector (not shown) that is coupled to connector sleeve 220. When used as an optical transmitter, optical transmitting device 215 is included. PCB 226 provides equalization of electrical signals and electrical to optical signal conversion, as appropriate. Second internal PCB 208 is electrically coupled to PCB 226 and adapts power and signals to the backplane or from PCB 226, and controls the optical power circuit, as appropriate depending on whether the module is an electrical or optical transmit or receive module. Four-pin electrical connector 210, carried on the underside of internal PCB 208, receives DC power and electrically couples module 200 to the mating connector on backplane 10 (or to a mating pin connector of a processing PCB, as explained below). Hold-down bracket 213 mechanically couples module 200 to the backplane or other PCB, using a mating mechanical structure on the backplane (not shown).

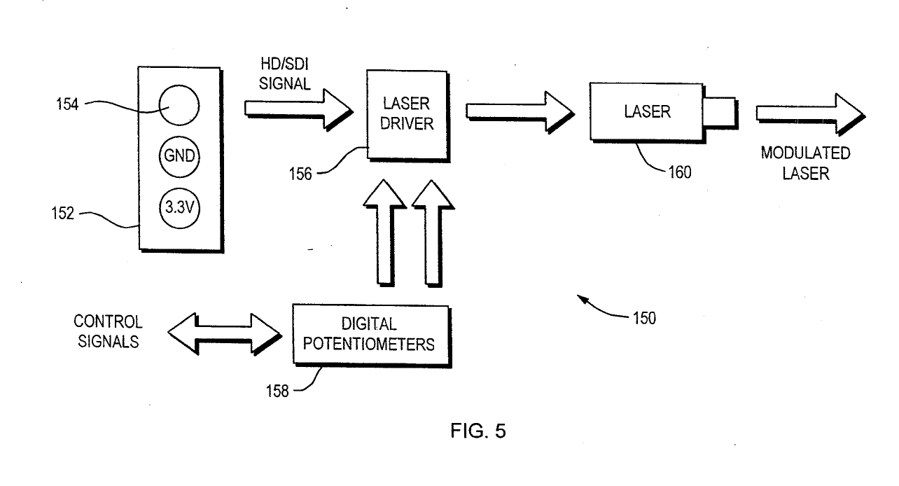

An optical transmit module 150 is functionally depicted in FIG. 5. Electrical connector 152 includes data pin(s) 154 and provides HD or SDI signals, for example, to laser driver 156. Digital potentiometers 158, under control of signals provided by a microprocessor (not shown), provide bias and modulation control of laser 160. The output is coupled to a standard optical connector such as shown in FIG. 3.

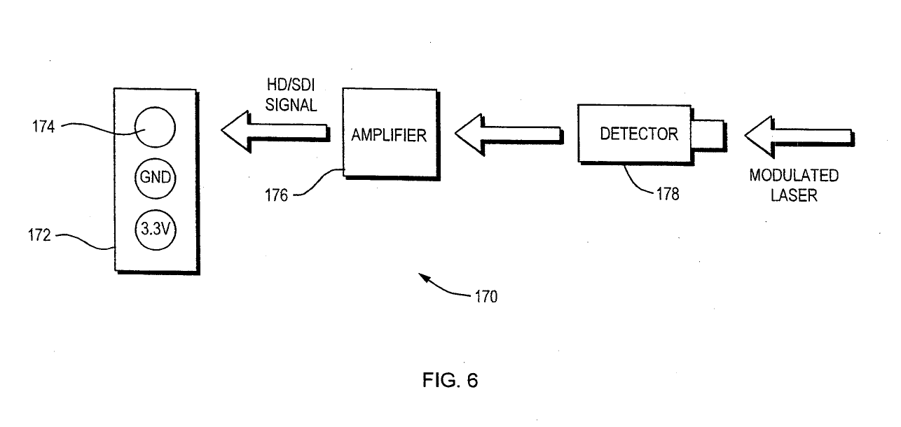

An optical receiver module 170 is functionally depicted in FIG. 6. Input signals are detected and converted to electrical signals by detector 178. These are then amplified by amplifier 176 and passed to the processing PCB through connector 172 that includes data pin(s) 174.

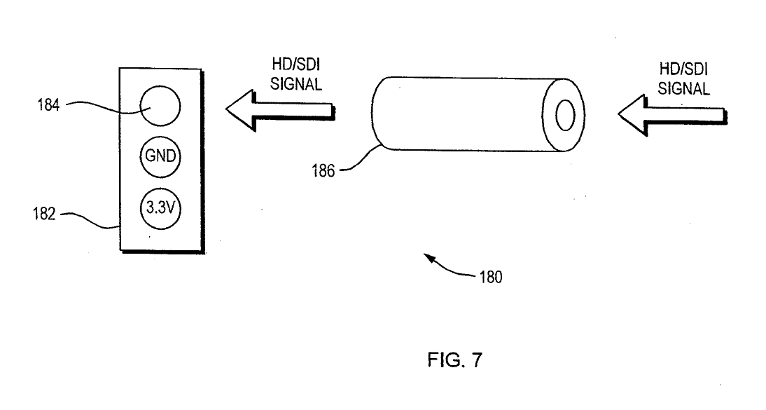

A pass-through BNC electrical input or output module 180 is functionally depicted in FIG. 7. BNC connector 186 is electrically coupled to the pins of connector 182, including data pin(s) 184. Module 180 can include any necessary processing so as to translate the format or repeat the incoming signals, for example.

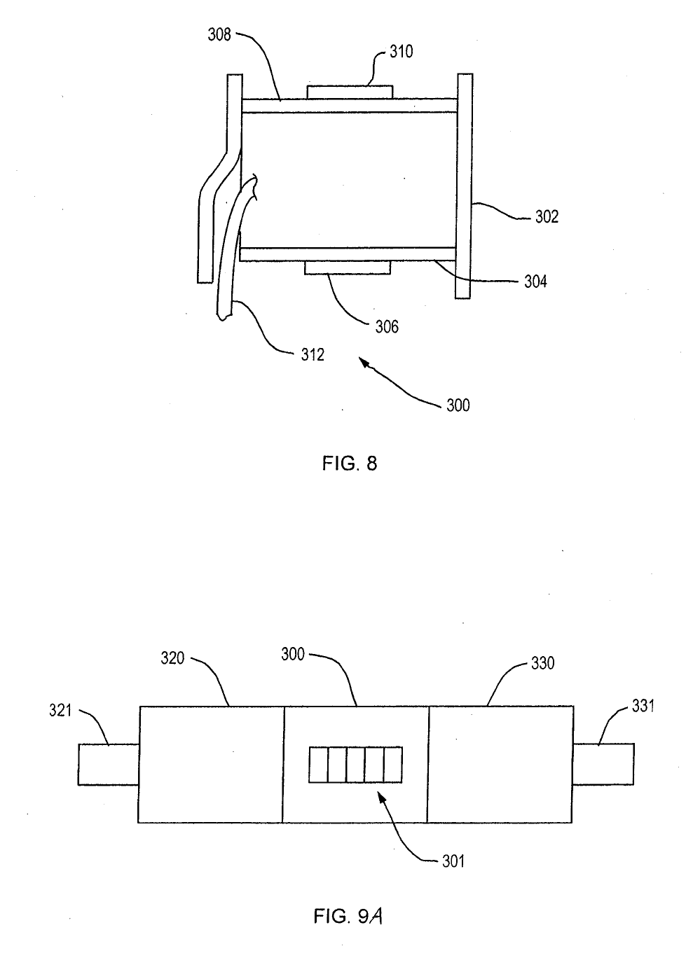

Connector module interface device 300 is shown in FIGS. 8, 9A and 10. Device 300 allows two of the inventive modules described above (one receive module and one transmit module) to be electrically interconnected to accomplish transfer of signals between them. With the use of the modules described above, this allows the creation of at least: an optical to electrical converter, an electrical to optical converter, an electrical repeater, an optical wavelength shifter, and an optical repeater. Power is supplied to device 300 through power cord 312. Housing 302 includes internal PCB 304 that carries input electrical connector 306, and internal PCB 308 that carries output electrical connector 310. Electrical connectors 306 and 310 are adapted to physically and electrically mate with the electrical connector 210 of an inventive module 200. Device 300 also includes mechanisms or features (not shown) that physically couple with the hold-down brackets of the connected modules, to mechanically couple the modules to device 300. Thus, two modules 200 can be electrically and physically coupled to device 300.

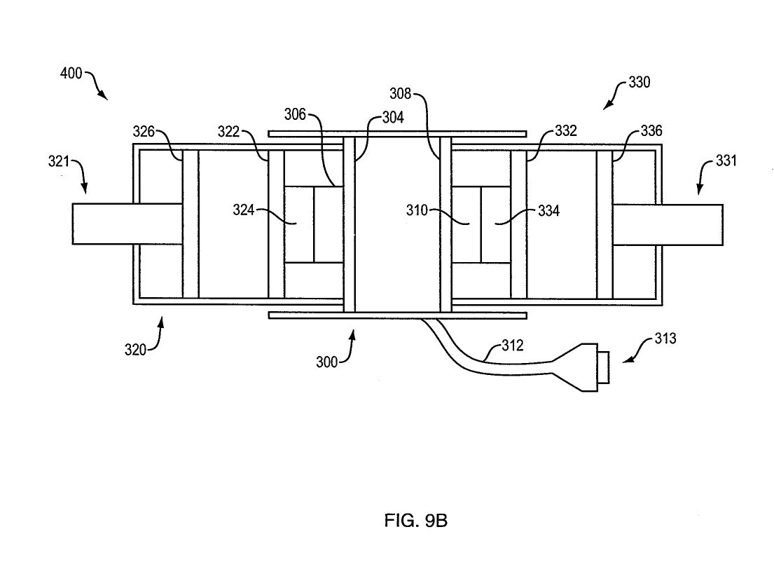

FIG. 9A depicts device 300 mated to inventive module 320 with protruding optical or electrical connector 321, and module 330 with protruding optical or electrical connector 331. Device 300 provides power through two of the four connector pins, and passes signals between the other pins of the connectors of the two interconnected inventive modules; device 300 may include other processing as desired, for example to translate or repeat the signals. Device 300 may also be adapted to measure the power used in a standard fashion, for example to determine when the device is in use. LED display 301 can be included to visually indicate the power level.

The invention also features a configurable, modular video data transport system 400, FIG. 9B, comprising a connector module 300 comprising an input multi-pin connector 306 mounted on PCB 304, and an output multi-pin connector 310 mounted on PCB 308. A step-down voltage regulator 406 is adapted to be connected to an external 12V power source (through USB cable 312 with USB connector 313) and provide a regulated power supply output that powers all aspects of the three interconnected modules comprising the system. Controller 408 is operatively coupled to the voltage regulator output, the input connector and the output connector.

System 400 comprises a series of receiver modules each comprising an input connector and an output connector, the output connector of each receiver module constructed and arranged to mate with the input connector of the connector module so that each receiver module can be directly mechanically and electrically coupled to the connector module and pass data signals that it receives to the connector module. At least one receiver module has a coaxial input connector adapted to be coupled to an input coaxial electrical cable carrying video data, and at least one receiver module has an optical fiber input connector adapted to be coupled to an input optical cable carrying video data. One of the receiver modules is mechanically and electrically coupled to the connector module via the receiver module output connector and is also coupled to the input cable, to thereby receive input data signals and pass them as electrical signals to the connector module.

System 400 further comprises a series of transmitter modules each comprising an input connector and an output connector, the input connector of each transmitter module constructed and arranged to mate with the output connector of the connector module so that each transmitter module can be directly mechanically and electrically coupled to the connector module to receive the data signals from the connector module that were input to the connector module by the receiver module. At least one transmitter module has a coaxial output connector adapted to be coupled to an output coaxial electrical cable that is adapted to carry electrical video data, and at least one transmitter module has an optical fiber output connector adapted to be coupled to an output optical cable that is adapted to carry optical video data. One of the transmitter modules is mechanically and electrically coupled to the connector module via the transmitter module input connector, and is also coupled to the output cable to thereby transmit electrical data signals received from the connector module, transmitted as either electrical or optical signals as appropriate.

The output of the voltage regulator of the connector module is operatively coupled to both the receiver module and transmitter module that are coupled to the connector module so as to provide power to operate the receiver module and transmitter module.

The connector module passes to the transmitter module signals received by it from the receiver module to be transmitted by the transmitter module. The connector module translates signals received by it from the receiver module as necessary such that the signals are of the correct format for transmission by the transmitter module.

In the example shown in FIG. 9B, connector module 300 is mechanically and electrically coupled to receiver module 320 via mating male electrical connector 324 of module 320 and female electrical connector 306 of module 300. Likewise, module 300 is mechanically and electrically connected to transmitter module 300 via female connector 310 and male connector 334, respectively. The modules can also include another means of mechanical interconnection between the receive and the transmit modules and the connector module. This may be accomplished by including two or more pins in each of the receive and transmit modules that are received in corresponding openings on the two opposed faces of the connector module. In this way, an electrical or optical video signal received into appropriate interface 321 (which is terminated on PCB 326) is transmitted by the inventive system as an electrical or optical video data signal via appropriate interface 331 (which is terminated on PCB 336).

Module 300 provides controlled DC power of the correct voltage to the receive and transmit modules with voltage regulator 406 that provides power through input connector 306 and output connector 310. Module 300 can accomplish any necessary translation or other signal processing or repeating needed to transmit the appropriate data signals, under control of microcontroller 408. Module 300 also includes LED 410 that is lit when the module is connected to an appropriate power source, indicating that it is ready for use. A series of (preferably four) LEDs 412 are included to indicate the power of the received signal (from receive module 320). In one non-limiting embodiment, these LEDs indicate the following ranges: 0, −5 dBm; −5, −10 dBm; −10, −15 dBm; and −15, −20 dBm.

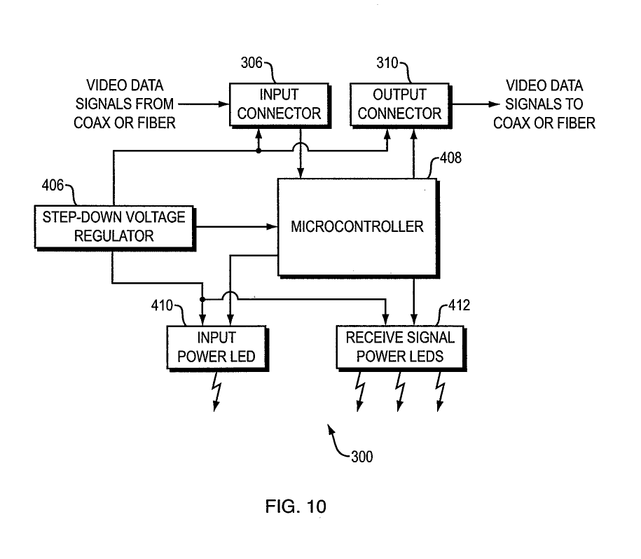

FIG. 10 depicts module 300 in schematic form, with input video data provided to input connector 306, and the video data outputted via output connector 310. Microcontroller 408 processes the signals. Step down voltage regulator 406 provides power to all powered elements of the module. Input power LED 410 lights when line power has been provided into the module, to voltage regulator 406. Receive signal LEDs 412 provide visual indication of the power of the received signal.

Non-limiting examples of optical receive and transmit modules are as follows.

### The Optical Receive Module Features are as Follows:

SMPTE297M-2006 compliant
Robust error free reception of signals from 10 Kb/s to 3 Gb/s with up to 30 km via single-mode fiber
Supports video pathological patterns for SD-SDI, HD-SDI and 3G-SDI
Pluggable and hot swappable
Digital diagnostic functions available through an I2C interface including:
   Monitoring of receive optical input
   Supply voltage and module temperature
   Alarm reporting
   Module ID polling
Low power consumption
Pb-free and RoHS compliant
Operating temperature: −40° C. to +70° C.
28 mm×17.5 mm×16.5 mm package
Standard ST fiber connector

### Applications of the Optical Receive Module Include:

Optical link for long haul

### Description of the Optical Receive Module:

A single channel optical receive module designed to convert signals from optical into electrical for applications defined in SMPTE 297M-2006. Supports data rates from 10 Kb/s to 3 Gb/s and is specifically designed for robust performance in the presence of SDI pathological patterns for SDI such as SMPTE-259M, SMPTE-344M, SMPTE-292M and SMPTE-424M. The module is fully compliant with 297M-2006.

The module contains one optical receiver, which is designed to provide a error-free reception of the signals at a long haul up to 30 km per SMF standard at data rates from 50 Mb/s to 3 Gb/s when interfaced with the transmitter module. The module is hot pluggable and operates with 3.3V power supply. The module provides extensive operational status monitoring via I2C interface for monitoring and alarming on optical input power, loss of signal, and operating temperature.

### The Optical Transmit Module Features are as Follows:

SMPTE297M-2006 compliant
Output frequency from 50 Mb/s to 3 Gb/s with up to 30 km via single-mode fiber
Supports video pathological patterns for SD-SDI, HD-SDI and 3G-SDI
Pluggable and hot swappable
Digital diagnostic functions available through an I2C interface including:
   Monitoring of transmit optical output
   Supply voltage and module temperature
   Alarm reporting
   Module ID polling
Low power consumption—typical 97 mW maximum
Pb-free and RoHS compliant
Operating temperature: −40° C. to +70° C.
28 mm×17.5 mm×16.5 mm package
Standard ST fiber connector

### Applications of the Optical Transmit Module:

Convert Electrical to Optical for long haul

### Description of the Optical Transmit Module:

The module is a single channel optical transmitter module to designed to transmit optical serial digital as defined in SMPTE 297M-2006. The module supports data rates from 50 Mb/s to 3 Gb/s and is specifically designed for robust performance in the presence of SDI pathological patterns for SMPTE-259M, SMPTE-344M, SMPTE-292M, and SMPTE-424M serial rates. The module is fully compliant with SMPTE-297M-2006. The module contains an optical output transmitter with 1310 nm wavelength and can drive up to 30 km of standard SFM with error-free transmission. The module is hot pluggable and operates at 3.3V supply. The module provides extensive operational status such as optical output, laser bias current, photo-diode current, internal temperatures, and alarms via I2C interface.

Although specific features of the invention are shown in some figures and not others, this is for convenience only, as some features may be combined with any or all of the other features in accordance with the invention.

Recitation of sizes, quantities, weights and ranges of values herein are merely intended to serve as a shorthand method of referring individually to each separate value falling within the range, unless otherwise indicated herein, and each separate value is incorporated into the specification as if it were individually recited herein.

The use of any and all examples, or exemplary language (e.g., “such as”) provided herein, is intended merely to better illustrate the invention and does not pose a limitation on the scope of the invention.

A variety of modifications to the embodiments described herein will be apparent to those skilled in the art from the disclosure provided herein. Thus, the invention may be embodied in other specific forms without departing from the spirit or essential attributes thereof

What is claimed is:

1. A configurable, modular video data transport system, comprising:
a connector module comprising an input connector, and output connector, a voltage regulator adapted to be connected to an external power source and provide a regulated power supply output, and a controller operatively coupled to the voltage regulator output, the input connector and the output connector;
a series of receiver modules each comprising an input connector and an output connector, the output connector of each receiver module constructed and arranged to mate with the input connector of the connector module so that each receiver module can be directly mechanically and electrically coupled to the connector module and pass data signals to the connector module, wherein at least one receiver module has a coaxial input connector adapted to be coupled to an input coaxial electrical cable carrying video data and at least one receiver module has an optical fiber input connector adapted to be coupled to an input optical cable carrying video data, and wherein one of the receiver modules is mechanically and electrically coupled to the connector module via the receiver module output connector, and is also coupled to the input cable, to thereby receive input data signals and pass them to the connector module;
a series of transmitter modules each comprising an input connector and an output connector, the input connector of each transmitter module constructed and arranged to mate with the output connector of the connector module so that each transmitter module can be directly mechanically and electrically coupled to the connector module to receive the data signals from the connector module that were input to the connector module by the receiver module, wherein at least one transmitter module has a coaxial output connector adapted to be coupled to an output coaxial electrical cable that is adapted to carry electrical video data, and at least one transmitter module has an optical fiber output connector adapted to be coupled to an output optical cable that is adapted to carry optical video data, and wherein one of the transmitter modules is mechanically and electrically coupled to the connector module via the transmitter module input connector, and is also coupled to the output cable to thereby transmit data signals received from the connector module;
wherein the output of the voltage regulator of the connector module is operatively coupled to both the receiver module and transmitter module that are coupled to the connector module so as to provide power to the receiver module and transmitter module, and wherein the connector module passes to the transmitter module signals received by it from the receiver module to be transmitted by the transmitter module, and wherein the connector module translates signals received by it from the receiver module as necessary such that the signals are of the correct format for transmission by the transmitter module.

2. The system of claim 1 wherein all of the receiver modules have the same size and shape housing and output connector, so that they can interchangeably couple to the connector module.

3. The system of claim 1 wherein all of the transmitter modules have the same size and shape housing and input connector, so that they can interchangeably couple to the connector module.

4. The system of claim 1 wherein all of the receiver modules and all of the transmitter modules have the same size and shape housing.
